(19) United States
(12) Patent Application Publication
(10) Pub. No.: US 2024/0356085 A1
(43) Pub. Date: Oct. 24, 2024

(54) ELECTROCHEMICAL CELL FOR STRUCTURAL BATTERY

(71) Applicant: VOLTA Structural Energy srl, Milano (MI) (IT)

(72) Inventor: Gabriele CONSIGLIO, Milano (MI) (IT)

(21) Appl. No.: 18/554,190

(22) PCT Filed: Mar. 28, 2022
(86) PCT No.: PCT/IB2022/052840

§ 371 Date: Oct. 5, 2023

(30) Foreign Application Priority Data
Apr. 6, 2021 (IT) 102021000008444

(51) Int. Cl. H01M 10/058; H01M 4/131; H01M 4/136; H01M 50/14; H01M 50/207; H01M 50/531

(52) U.S. Cl. CPC H01M 10/058; H01M 4/131; H01M 4/136; H01M 50/14; H01M 50/207; H01M 50/531

(57) ABSTRACT

An electrochemical cell includes two external plates which are mutually parallel and spaced apart and each including a second electrode extending along a expansion plane defining an internal surface of each external plate, and a connective element capable of mutually connecting the internal surfaces of the external plates including at least one honeycomb structure defined by a plurality of walls extending parallel to a first expansion direction and together making a first electrode having high stiffness parallel to the expansion direction and deformable perpendicularly to the expansion direction, and in which each second electrode is transverse to the first expansion direction, and in which the external plates and the connective element define a sandwich panel capable of absorbing mechanical energy in case of impact at least along the expansion direction and of carrying out loading and unloading processes without deformation.

The present invention relates to an electrochemical cell for a structural battery of the type specified in the preamble to the first claim.

Various structural batteries are currently under development. The structural batteries comprise, in brief, innovative multifunctional composite materials capable of supporting mechanical loads and storing electrical energy at the same time. These batteries are significantly smaller in size and weight than conventional batteries of comparable energy efficiency. The structural batteries have many potential applications. Possible fields of use are: the automotive sector, the aerospace sector, the construction sector, the energy sector, in particular the renewable energy sector, and more.

The adoption of such structural batteries is particularly suitable for solving space-related problems.

For example, as is well known, the main problem with electric cars today is their low range. In order to guarantee high autonomy, it would be necessary to implement large conventional batteries in the vehicles. However, these have the disadvantage of significantly increasing the weight of the vehicle and thus increasing consumption. To overcome this problem, cars have been designed with accumulators integrated into the bodywork. Some parts of the bodywork are made of composite materials which are designed to store energy and at the same time provide mechanical resistance to the structure. This integrated construction concept can be applied in all of the above areas and also involves significant changes in the shape and/or size of structures and electrical devices.

In recent years, the most studied approach to realising multifunctional composite materials has been to incorporate thin-film batteries within composite laminates to create a multifunctional structure. For example, the properties of lithium-ion batteries can be combined with the properties of carbon fibre composite materials. The carbon fibres provide structural strength and are also the negative electrode in lithium-ion batteries. These fibres must be placed in a matrix to ensure high mechanical performance. The matrix must also allow the ion exchange necessary for energy storage between the negative and positive electrodes. This matrix is mainly made of polymeric materials since liquid electrolytes are not suitable for mechanical loads in these configurations.

An alternative approach is to make structural electrodes, structural separators and even a structural electrolyte that are themselves suitable for forming a battery, e.g. lithium-ion.

The known technique described involves some major drawbacks.

In particular, the solutions studied so far have not produced a satisfactory combination of high energy storage and high structural strength.

Some technologies present the problem of structural deformation during the charging and discharging process.

In addition, damage or malfunctioning could lead to the replacement of large structural parts at high costs.

In this situation, the technical task underlying the present invention is to devise an electrochemical cell for structural battery capable of substantially obviating at least part of the aforementioned drawbacks.

In the context of said technical task, it is an important aim of the invention to obtain an electrochemical cell for a structural battery which guarantees high mechanical resistance and, at the same time, high energy efficiency.

Furthermore, it is desirable that such a structural battery is not subject to deformation during charging and discharging processes.

Another important scope of the invention is to realize an electrochemical cell for structural battery that can be repaired at low cost in case of malfunction or damage.

The specified technical task and purposes are achieved by an electrochemical cell for structural battery as claimed in the annexed claim 1.

Preferred technical solutions are highlighted in the dependent claims.

The features and advantages of the invention are hereinafter clarified by the detailed description of preferred embodiments of the invention, with reference to the appended drawings, wherein:

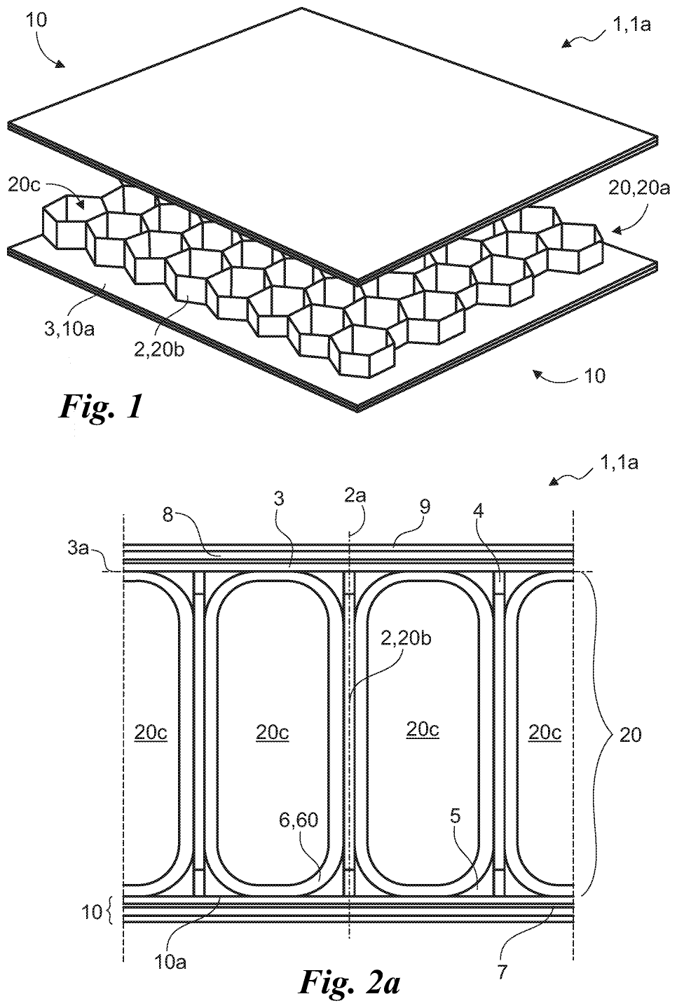

the FIG. 1 shows an exploded view of a sandwich panel of an electrochemical cell for structural battery according to the invention;

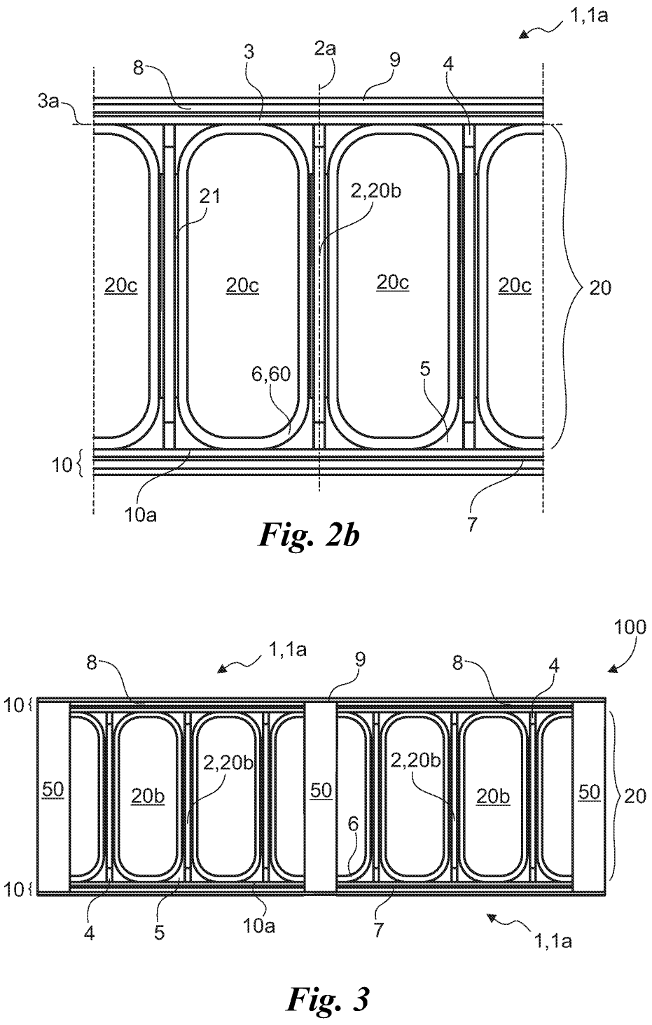

the FIG. 2a illustrates a cross-section of a sandwich panel of an electrochemical cell for structural battery according to the invention;

the FIG. 2b illustrates a cross-section of the sandwich panel of an electrochemical cell for structural battery according to the invention in which the walls of the honeycomb structure comprise the active layer;

the FIG. 3 shows a cross-section of two electrochemical cells for structural battery according to the invention structurally connected to each other;

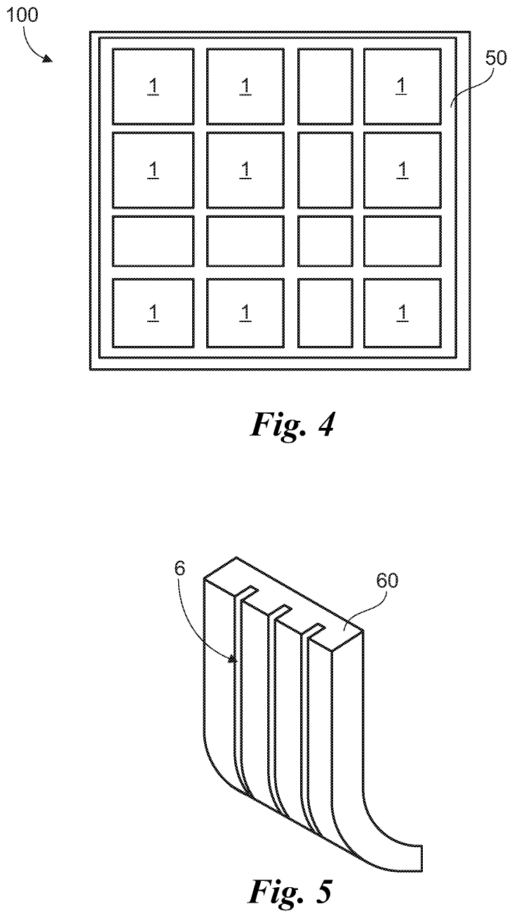

the FIG. 4 is a top view of a structural battery made from a set of structurally connected structural battery electrochemical cells according to the invention; and

the FIG. 5 shows a detail of the retaining element with grooves of the electrochemical cell according to the invention.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices. The measurements and data reported in this text are to be considered, unless otherwise indicated, as performed in the International Standard Atmosphere ICAO (ISO 2533:1975).

With reference to the Figures, the electrochemical cell for structural battery according to the invention is globally referred to as 1.

The electrochemical cell 1 is capable of being included, or constituting, a structural battery, as further specified below.

The electrochemical cell 1, in brief, comprises, or consists of, at least two external plates 10 and a connective element 20.

The plates 10 are substantially flat elements which define, in the three-dimensional space, two dimensions preponderant over the third dimension.

The connective element 20 is substantially a component interposed between the external plates 10. Therefore, the connective element 20 connects the plates 10 by spacing them apart.

Advantageously, the plates 10 and the connective element 20 essentially define a sandwich panel 1a. By sandwich panel it is understood, of course, that the electrochemical cell 1 includes a panel or plate element, in which namely two dimensions preponderate over the third dimension, defined by a plurality of layers stacked in succession.

The successively overlapping layers are preferably respectively at least one external plate 10, the connective element 20, and another external plate 10. In a preferred, but not exclusive, embodiment, the sandwich panel 1a may comprise precisely the two outer sheets 10 and the connective element 20.

In any case, the two outer sheets 10 are, as already mentioned, preferably mutually parallel and spaced apart. Each of the external plates 10 defines an internal surface 10a.

The connective element 20 is suitable to connect, in detail, the internal surfaces 10a of the two external plates 10 to each other. Said connective element 20 preferably includes a honeycomb structure 20a. In particular, the honeycomb structure 20a is defined by a plurality of walls 20b. The walls 20b are preferably flat, thin elements. Such walls 20b preferably extend parallel to a first expansion direction 2a. In particular, within the honeycomb structure 20a, the walls 20b define cavities 20c. The cavities 20c are preferably columnar in shape, more preferably hexagonal in shape. Of course, the overall shape of each cavity 20c and the arrangement of the walls 20b could be of different types. For example, as known, the walls 20b could be wavy and mutually constrained to make the honeycomb structure 20a. Or, the cavities 20c could define staggered quadrangular shapes or even more complex shapes organised as a honeycomb structure as better defined below.

In particular, in fact, as is known, honeycomb structures have specific characteristics that should not be confused with simple grids or other separating elements. The honeycomb structures and, in particular, the honeycomb structure 20a are characterised by the fact that each cavity 20c is separated from the surrounding cavities 20c by at least one wall 20b. In a triangular or rectangular columnar cavity 20c structure, this may not be the case since the cavities 20c may be separated from some surrounding cavities 20c solely by the point where walls 20b meet.

In other words, advantageously, the connective element 20 defines exactly a honeycomb structure 20a.

The walls 20b preferably define thicknesses, transverse to the expansion direction 2a,of between 10 μm and 300 μm, more preferably between 50 μm and 70 μm.

Furthermore, the walls 20b may extend parallel to the expansion direction 2a by a length of between 1 mm and 1 dm, more preferably between 3 mm and 5 cm. In any case, preferably, the walls 20b define high mechanical properties. Preferably, they define a minimum elastic modulus of 50 GPa. Thus, the walls 20b, being in fact the elements separating the outer plates 10, allow mechanical loads to be transferred between them.

Furthermore, the walls 20b may comprise holes. These, if present, are configured to place in fluid passage connection the cavities 20c. Such holes are preferably designed to allow air to escape from the electrochemical cell 1 during the production process.

In any case, the walls 20b make, together, a first electrode 2. Preferably, the first electrode 2 defines the anodic part of the electrochemical cell 1.

By the term together it is meant that preferably the entire honeycomb structure 20a substantially constitutes the first electrode 2 and, therefore, each wall 20b is a component of the same first electrode 2. Furthermore, the walls 20b may comprise an active layer 21.

Furthermore, the first electrode 2 preferably has high stiffness parallel to the development direction 2a. In particular, as explained above, the stiffness of the electrode 2 is given by the walls 20b which define an elastic modulus, or Young's modulus, of at least 50 GPa. Perpendicular to the expansion direction 2a, the first electrode 2 is preferably deformable.

The first electrode 2 is electrically conductive. In particular, the honeycomb structure 20a may be made entirely of electrically conductive material or it may comprise a non-conductive material and a conductive coating. A first example embodiment of the first electrode 2 comprises an electrically conductive honeycomb structure 20a made of aluminium, as shown in FIG. 2a. In addition, the honeycomb structure 20a can be made from flame resistant materials such as Nomex. Materials such as Nomex, not being electrically conductive, require a coating of conductive material. If present, the coating preferably covers the entire honeycomb structure 20a. In more detail, such a coating can define thicknesses between 1 μm and 10 μm. It may be made of aluminium, titanium nitride or other conductive metallic or ceramic materials. In particular, the conductive coating is designed to improve the electrical conductivity of the material constituting the honeycomb structure 20a. It is also suitable for protecting the material of the honeycomb structure 20a from chemical aggression of certain substances present in the electrochemical cell 1.

The walls 20b may additionally comprise an active layer 21 as shown in FIG. 2b. The active layer 21 is configured to cover, at least partially, the walls 20b. Preferably, it entirely covers the walls 20b. The active layer 21 may be made from chemical compounds such as LiCoO2, LiMnO2, LiFePO4 or other similar. Preferably, in general, by active layer 21 is meant a material that participates in the electrochemical oxidation-reduction reaction as an anode or cathode, for example as a cathode in the case of LiCoO2, LiMnO2, LiFePO4 or other similar. The walls 20b may therefore comprise the active layer 21 whether the honeycomb structure 20a is electrically conductive or non-conductive and comprises a conductive coating. In particular, the presence of the active layer 21 depends on the particular reactions that must take place in the electrochemical cell 1.

The external plates 10 each comprise a second electrode 3. The second electrode 3 preferably defines the cathodic portion of the electrochemical cell 1. Such second electrode 3 extends along an expansion plane 3a defining the internal surface 10a. Therefore, the second electrode 3 substantially occupies the innermost layer of each external plate 10 and, therefore, it realizes the internal surface 10a or, in other words, a face thereof corresponds to the internal surface 10a of the external plate 10. The expansion plane 3a, in addition, is at least transverse to the first development direction 2a, preferably moreover it is perpendicular. Therefore, the second electrode 3 itself is substantially transverse to the first electrode 2, i.e. to the walls 20b of the honeycomb structure 20a.

In detail, the second electrode 3 is preferably made of carbon. More preferably, it may be made of graphite, graphene, activated carbon or otherwise. In addition, it may also be made of polymeric material, for example polypyrene. A particular embodiment involves a composite material containing carbon fibres in a polymer or graphite matrix. Specifically, the graphite matrix may be made by pyrolysis from a precursor material such as phenolic resin or by vapor deposition (CVD) of methane. Furthermore, such a matrix may comprise two overlapping layers respectively made by the aforementioned processes. A further embodiment of the second electrode 3 comprises functionalising the graphitic matrix by means of recycled carbon powder or by means of nanostructured carbon. For example, the nanostructured carbon may be in the form of carbon nanotubes (CNTs) or other similar. Furthermore, the second electrode 3 preferably has a porosity of between 5% and 95%. In the case where said electrode 3 is made of a composite material, it is the matrix that has the indicated porosity. In particular, the porosity of the second electrode 3 is suitable to favour the absorption of the electrolyte and to increase the electrochemical properties of the cell 1. Internally to the electrochemical cell 1, the first electrode 2 and the second electrode 3 are electrically separated from each other. In fact, the electrochemical cell 1 comprises an insulator 4 positioned at the contact areas between the two electrodes. Naturally, the insulator 4 is interposed between the electrodes 2 and 3 and, therefore, in fact makes the contact, that is, the mechanical connection, between the first electrode 2 and the second electrode 3.

The insulator 4 is preferably made of plastic materials. More preferably, it may be made from resins, thermoplastic polymers, elastomeric polymers or a combination thereof. In the case where the first electrode 2 is made of aluminium, it is possible to obtain electrical insulation between the two electrodes 2 and 3 by surface treatment, preferably by anodising. Anodising transforms aluminium into aluminium oxide, which is electrically insulating.

Obviously, the first electrode 2 and the second electrode 3 are electrically connected to each other by means of an electric circuit external to the electrochemical cell 1. This electric circuit allows the electrons developed at the first electrode 2 to migrate towards the second electrode 3 producing, therefore, an electric current.

In any case, this circuit and the method of electrical connection of the cell 1 to the circuit itself are widely known in the present state of the art and are not, therefore, described in detail.

The electrochemical cell 1 further comprises structural adhesive elements 5. The adhesive elements 5 are suitable for solidly connecting the second electrode 3 and the first electrode 2. They are preferably located in correspondence with the contact zones between the second electrode 3 and the first electrode 2, or in correspondence with the insulator 4 if the latter is present. The adhesive elements 5 are preferably made of insulating materials including, preferably, epoxy resins, polyester resins, thermoplastic materials, polyacrylamide or others.

In addition, the adhesive elements 5 are structural in the sense that they preferably define appropriate characteristics. For example, the adhesive elements define a tensile strength of at least between 20 MPa and 30 MPa. In addition, the structural elements 5 may define other characteristics including one or more of elastic modulus between 600 MPa and 700 MPa, shear strength between 15 MPa and 35 MPa, and thermal resistance of at least up to 120° C.

The electrochemical cell 1 preferably further comprises an electrolyte 6.

The electrolyte 6 is arranged in contact with the first electrode 2 and the second electrode 3. The electrolyte 6, therefore, contacts the surfaces of the electrodes 2 and 3 facing the inside of the cavities 20c of the honeycomb structure 20a. Said electrolyte 6 is suitable to allow ion transfer between the first electrode 2 and the second electrode 3. The electrolyte 6 is preferably liquid. More preferably, it may be a solution of: AlCl3 and urea or a solution of AlCl3 and [EMIM] Cl. Such solutions preferably have a molar ratio between 1.1:1 and 2:1. In fact, it is necessary that the aluminium chloride is in molar excess in order to react. The electrolyte 6 may further comprise salts such as LiPF6, KFSI or other similar. Such salts are preferably dissolved in solvents with carbonate esters such as ethylene carbonate, ethyl methyl carbonate, dimethyl carbonate or others. In addition, the electrolyte 6 may comprise a gel. Preferably, such a gel comprises one of the previously mentioned liquids and a polymer.

In the case where the electrolyte 6 is a liquid, the electrochemical cell 1 may comprise a containment element 60. The containment element 60 is preferably polymeric. It is arranged in correspondence with the surfaces of the electrodes 2 and 3 facing the cavities 20c. In particular, it has a thickness such that it covers the surfaces of the electrodes 2 and 3 but without significantly occupying the cavities 20c. A preferred embodiment provides a porous containment element 60 suitable to accommodate said electrolyte 6 within its pores. A further embodiment comprises a containment element 60 comprising grooves at the surfaces of the electrodes 2 and 3 as shown in FIG. 5. Such a containment element 60 is preferably impermeable to the electrolyte 6. In particular, however, the grooves are configured to allow the passage of the electrolyte 6, from one electrode to the other, by capillarity.

The cavities 20c comprise, therefore, the electrolyte 6 substantially at the walls 20b. The interior of the cavities 20c of the structure 20a is preferably occupied by a gas. The gas makes it possible to maintain a pressure in the electrochemical cell 1 equal to the external pressure, thus avoiding creating internal stresses. Said gas may be dry air or inert gas. Preferably, the inert gas is argon, carbon dioxide, nitrogen, or helium. Both the dry air and the inert gas preferably have a water content of less than 100 ppm so as not to impair the operation of the electrochemical cell 1. Furthermore, during the construction of said electrochemical cell 1, the air contained in the cavities 20c may be extracted so as to create a vacuum-sealed cell 1.

The external plates 10 may further comprise a current collector 7. In particular, it is positioned on the face of the second electrode 3 opposite the surface 10a. The collector 7 may comprise wires or thin foils. Preferably, such elements are made of copper, aluminium, steel or carbon fibres. They are also preferably coated with titanium nitride or other conductive ceramic materials. The coating enables chemical insulation of the collector 7 from the electrolyte 6. An alternative embodiment involves the deposition of titanium nitride, or other inert conductive material, directly on the face of the second electrode 3 opposite the surface 10a. The current collector 7 is suitable to distribute the current flow entering and leaving the second electrode 3. Furthermore, it is suitable to minimize the electrical resistance encountered by the electrons entering and leaving the second electrode 3. In particular, the current collector 7 has an electrical conductivity higher than that of the material constituting the second electrode 3. In fact, the second electrode 3 may comprise carbon fibres preferably immersed in a polymeric or carbonaceous matrix. Such carbon fibres are characterised by high conductivity and, therefore, act both as an active material of the second electrode and as a current collector.

The external plates 10 may additionally comprise a protective layer 8. This protective layer 8, if present, is positioned in contact with the current collector 7. If no such collector is present, the layer 8 is directly in contact with the surface of the second electrode 3 opposite the surface 10a. The protective layer 8 is suitable to isolate the electrochemical cell from the external environment. In particular, it is suitable to prevent the electrolyte 6 from escaping from the cell 1. This layer 8 may be made of different materials. For example, it may be made of acrylic materials, epoxy resins, polyurethane materials, metal foils, polymers reinforced with glass fibres or carbon or aramid fibres. It can also be made from a combination of these materials. For example, a layer of aluminium or titanium nitride of a thickness preferably between 1 μm and 10 μm may be deposited on top of a layer of epoxy resin or polyurethane.

The outer sheets 10 may comprise an additional structural layer 9. This layer is intended to increase the mechanical strength of the electrochemical cell 1. The structural layer 9, if present, is preferably made of a material of choice from those mentioned for the protective layer 8.

The electrochemical cell 1 is suitable for assembly with other electrochemical cells 1. In particular, a plurality of electrochemical cells 1 electrically connected to each other defines a structural battery 100.

By structural battery 100 is meant a load supporting battery, or load bearing battery. More particularly, the structural battery 100 is a battery capable of withstanding high mechanical loads.

The electrochemical cells 1 may be electrically connected to each other in series or in parallel.

Furthermore, said cells 1 may be structurally connected to each other by means of an insulating element 50. The insulating element 50 is preferably interposed between each sandwich panel 1a. Said element 50 is preferably made of one or more of the materials mentioned for the protective layer 8.

The electrochemical cells 1 may be arranged side by side or on top of each other. Overlapping of the electrochemical cells 1 may be achieved in various ways. In particular, the electrochemical cells 1 may share the second electrode 3. Alternatively, they may not share the second electrode 3 and thus be mutually separated by the structural layer 9. A further embodiment comprises adding a layer of material between the two overlapping cells 1 which thus do not share any element. The additional material is intended to increase the distance between the two cells 1. Such a material may be a polymer layer, a wood layer, a foam or other. In particular, the number and arrangement of the electrochemical cells 1, depends on the voltage to which the structural battery 100 is to be brought.

The operation of the electrochemical cell 1 described above in structural terms is as follows.

The electrochemical cell 1 is suitable for carrying out particular chemical reactions within it, preferably reactions belonging to the “Dual Ion” category. As is known, such reactions are reversible. In particular, one or more direct reactions define the charging process while corresponding reverse reactions define the discharging process.

In a preferred embodiment, the electrochemical cell 1 comprises a first electrode 2 made of aluminium and a second electrode 3 made of graphite. During the charging process, PF₆⁻ ions contained in the electrolyte 6 intercalate in the second electrode 3, while Li+ ions contained in the electrolyte are deposited on the first electrode 2 forming an Al—Li alloy. The discharge process is the reverse of the charging process and involves the backscattering of both PF₆⁻ and Li⁺ ions in electrolyte 6. The electrons flow through the external electrical circuit, generating current. During the charging process, electrons released from Lit ions upon intercalation with graphite flow from the second electrode 3 to the first electrode 2 making it possible to form the Al—Li alloy. During the discharge process, the flow of electrons between the electrodes is reversed.

The electrochemical cell 1 according to the invention achieves important advantages. Indeed, the electrochemical cell has structural electrodes which make the cell itself sufficiently robust and able to adequately absorb mechanical energy in the event of impact.

In particular, the electrochemical cell 1 does not present the problem of structural deformation during the charging and discharging process since the electrodes are perpendicular to each other.

In addition, the structural configuration makes it possible to obtain a battery with high energy efficiency and significantly light weight.

In case of damage, it is possible to replace only the damaged electrochemical cell without having to intervene on the entire structure, thus containing repair costs.

The invention is susceptible to variations within the scope of the inventive concept as defined by the claims.

Within this scope, all details are substitutable by equivalent elements and the materials, shapes and dimensions can be any.

1. Electrochemical cell for structural battery comprising:
two external plates which are parallel and spaced apart and each comprising a second electrode extending along an expansion plane defining an internal surface of each said external plate, and
a connective element suitable for reciprocally connecting said internal surfaces of said external plates,
and wherein:
said connective element includes at least one honeycomb structure defined by a plurality of walls extending parallel to a first expansion direction and realizing together a first electrode having high rigidity parallel to said expansion direction and deformable perpendicularly to said expansion direction,
each said second electrode being transverse to said first expansion direction, and
said external plates and said connective element define a sandwich panel suitable to absorb mechanical energy in case of impact at least along said expansion direction and to carry out loading and unloading processes without deformation.

2. Electrochemical cell according to claim 1, wherein said first electrode and said second electrode are reciprocally electrically separated by means of an insulator positioned in correspondence with contact zones defined between said first electrode and said second electrode.

3. Electrochemical cell according to claim 1, comprising structural adhesive elements solidly connecting said first electrode and said second electrode.

4. Electrochemical cell according to claim 1, comprising an electrolyte disposed in contact with said first electrode and said second electrode and suitable to allow ion transfer between said two electrodes.

5. Electrochemical cell according to claim 4, wherein said electrolyte contacts said first electrode and said second electrode and is contained within a polymeric containment element covering said electrodes.

6. Electrochemical cell according to claim 1, wherein each of said walls comprises an active layer configured to enable certain chemical reactions necessary for the operation of said electrochemical cell and made from one or more at a choice of LiCoO2, LiMnO2, LiFePO4 or other similar.

7. Electrochemical cell according to claim 1, wherein at least one of said external plates comprises a protective layer extending on a face of said second electrode opposite to said internal surface and suitable to isolate said sandwich panel from an external environment.

8. Electrochemical cell according to claim 1, wherein at least one of said external plates comprises a current collector positioned on a face of said second electrode opposite said internal surface suitable for distributing current flow and positioned between said second electrode and said protective layer.

9. Structural battery according to claim 1, comprising a plurality of said electrochemical cells.

10. Structural battery according to claim 9, wherein said electrochemical cells are structurally connected to each other by means of an insulating element interposed between each adjacent said sandwich panel.
